(19) United States
(12) Patent Application Publication
(10) Pub. No.: US 2018/0098513 A1
(43) Pub. Date: Apr. 12, 2018

(54) Growth Efficiency System

(71) Applicant: Brian Richie Designs Incorporated, Newport Beach, CA (US)

(72) Inventor: Brian Ritchie, Laguna Beach, CA (US)

(21) Appl. No.: 15/726,868

(22) Filed: Oct. 6, 2017

Related U.S. Application Data
(60) Provisional application No. 62/405,203, filed on Oct. 6, 2016.

(51) Int. Cl. A01G 9/14; A01G 9/20; A01G 9/24

(52) U.S. Cl. CPC A01G 9/1423; A01G 9/247; A01G 9/243; A01G 9/20

(57) ABSTRACT

A system to improve plant growth including a building having an interior and an interior ceiling. The system also includes a series of tiered structures configured in a stepped manner within the building interior and a plurality of lights hung from the ceiling of the building in a stepped manner to mirror the stepped manner of the tiered structures. A series of shelves is positioned on the tiered structures and arranged to place a plurality of horticulture products thereon. The lighting may include solar cells and a solar recycling system associated with the lighting.

### BACKGROUND OF THE INVENTION

### 1. Field of the Invention

The present invention relates to systems and structures used to grow plants indoors. More particularly, the present invention relates to systems and structures that maximize the use of space and energy to optimize plant growth in a cost-effective manner.

### 2. Description of the Prior Art

Growing horticulture produce indoors requires a lot of space. Often it also requires different climates and light cycles, requiring different rooms within the indoor structure. The process of growing produce indoors also requires watering the plants, which can be inefficient and wasteful of water. In particular, a substantial amount of space is required to grow plants indoors when essentially only one level is used in the building, or at least the building space is not used effectively. See, for example, the space configuration for plant growth represented in FIGS. 1 and 3, which show single level plant stands and parallel lighting. What is needed is a better system and associated combinations of components to improve indoor plant growth in a cost-effective manner.

### SUMMARY OF THE INVENTION

The present invention is a growth efficiency system that may be used to improve indoor plant growth in a cost-effective manner. The system improves the efficiency of many of the processes that go into growing produce indoors, including real estate footprint, lighting, watering and other processes.

The growth efficiency system of the present invention includes a triangular structure that is a tiered structure, which allows the horticulturist to access vertical space within a building, therefore allowing for increased space efficiency and other benefits. It resembles bleacher seating commonly found at a sporting event. Plants occupy the tiered structure on the top side of the structure, and produce can also be grown underneath the structure with a separate lighting system and climate, etc. The system incorporates custom watering and lighting systems, along with HVAC and other systems designed specifically for use in conjunction with the structure.

Increased efficiency takes the form of reduced need for additional square footage of the building for a volume of plants that would otherwise require much greater space for growing. The triangular structure of the system allows light to be better distributed and recycled via solar cells. In addition, runoff of water is easily managed via gravity and can be collected, filtered and recycled. The result of using the system of the present invention is improved cost savings, more efficient processes in growing plants and improved ergonomics for the horticulturists performing the job tasks. These and other advantages of the invention will become apparent upon review of the following detailed description, the accompanying drawings and the appended claims.

### BRIEF DESCRIPTION OF THE DRAWINGS

FIG. 1 is a simplified elevation view of a plant growth building of the prior art.

FIG. 2 is a simplified elevation view of a plant growth building of the prior art modified to include the growth efficiency system of the present invention.

FIG. 3 is a simplified plan view of component layout in a plant growth building of the prior art.

FIG. 4 is a simplified plan view of component layout of the growth efficiency system of the present invention.

FIG. 5 is a perspective view of a combination of two tiered structures of the present invention coupled together.

FIG. 6 is a side view of the tiered structure.

FIG. 7 is a representation of the watering manifold associated with the tiered structure.

FIG. 8 is a simplified side view representation of the tiered structure and lighting system of the present invention with plants depicted as efficiently arranged for growth.

FIG. 9 is a plan view of the layout of the interior of the tiered structure with utility component positioning.

FIG. 10 is a representation of two ways of conveying plants on the tiered structure.

FIG. 11 is a representation of the water conveyance of the growth efficiency system of the present invention.

FIG. 12 is a representation of the optional water purifier of the present invention.

FIG. 13 is a perspective view of the tiered lighting system with solar panel power capture arrangement.

FIG. 14 is a series of illustrations showing exploded views and step configurations for the tiered structure of the growth efficiency system of the present invention.

### DETAILED DESCRIPTION OF THE INVENTION

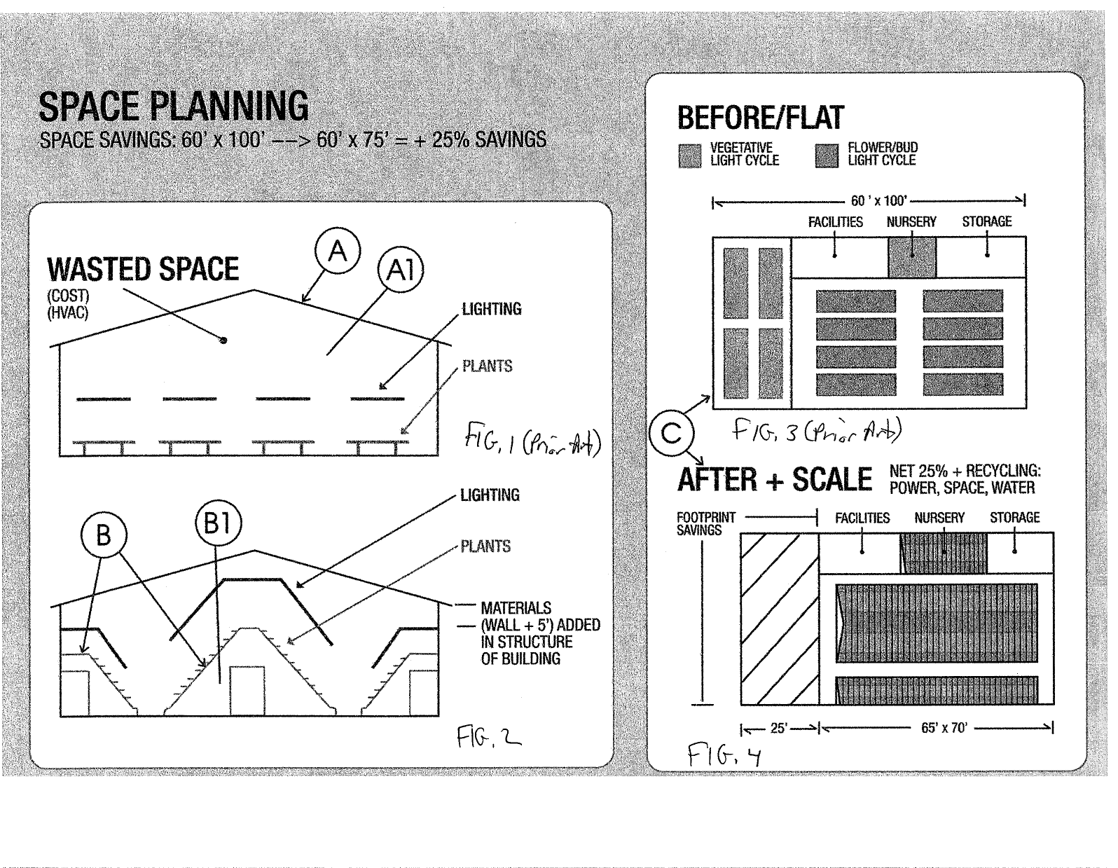

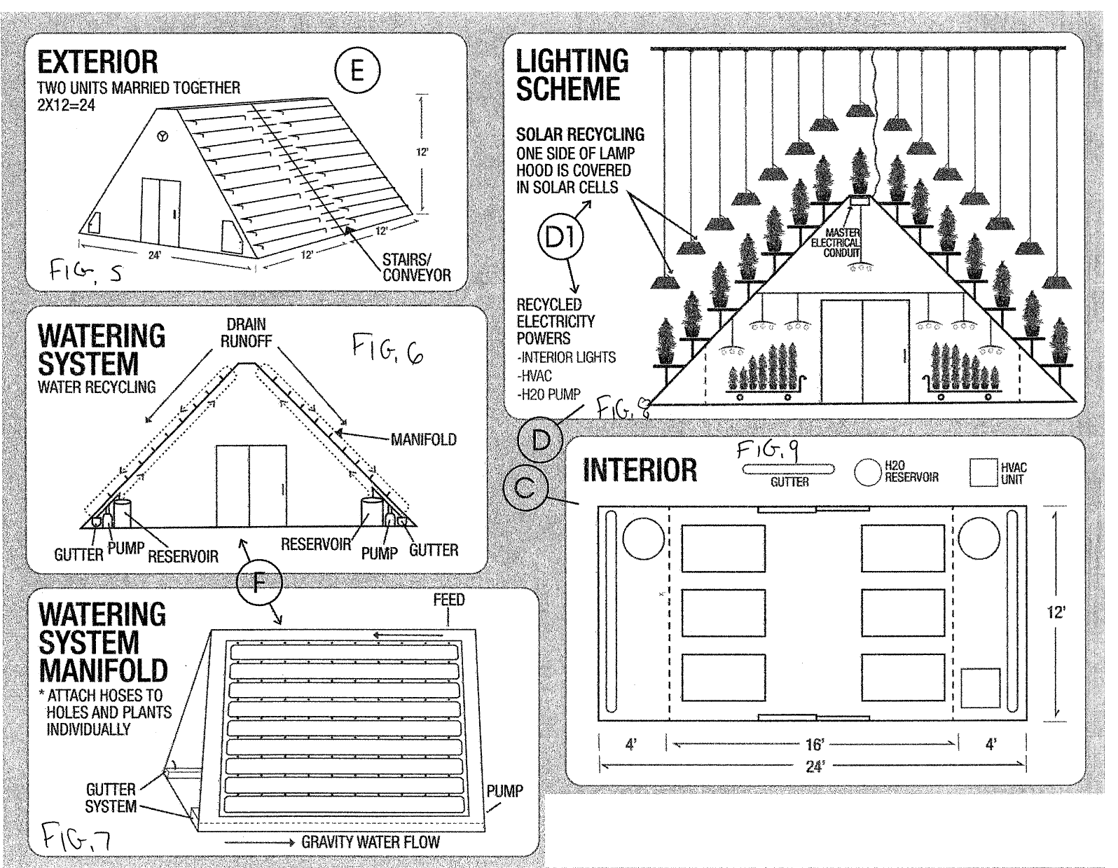

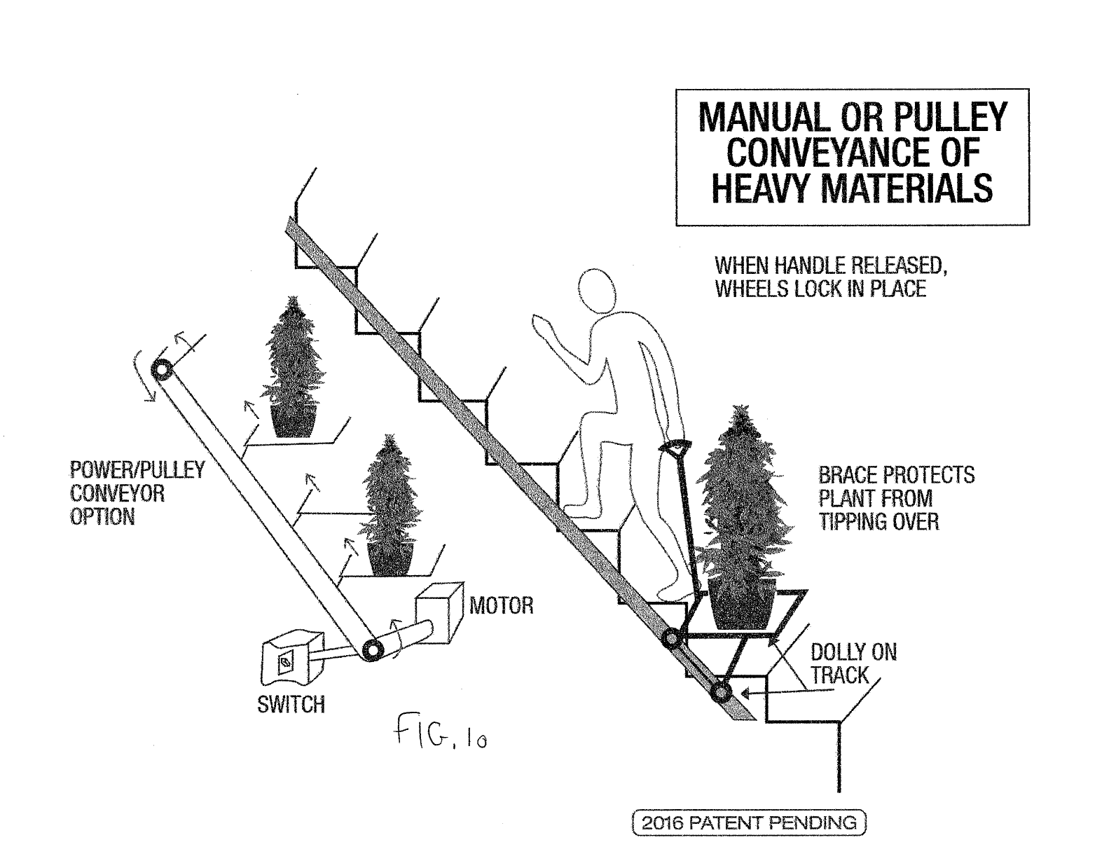

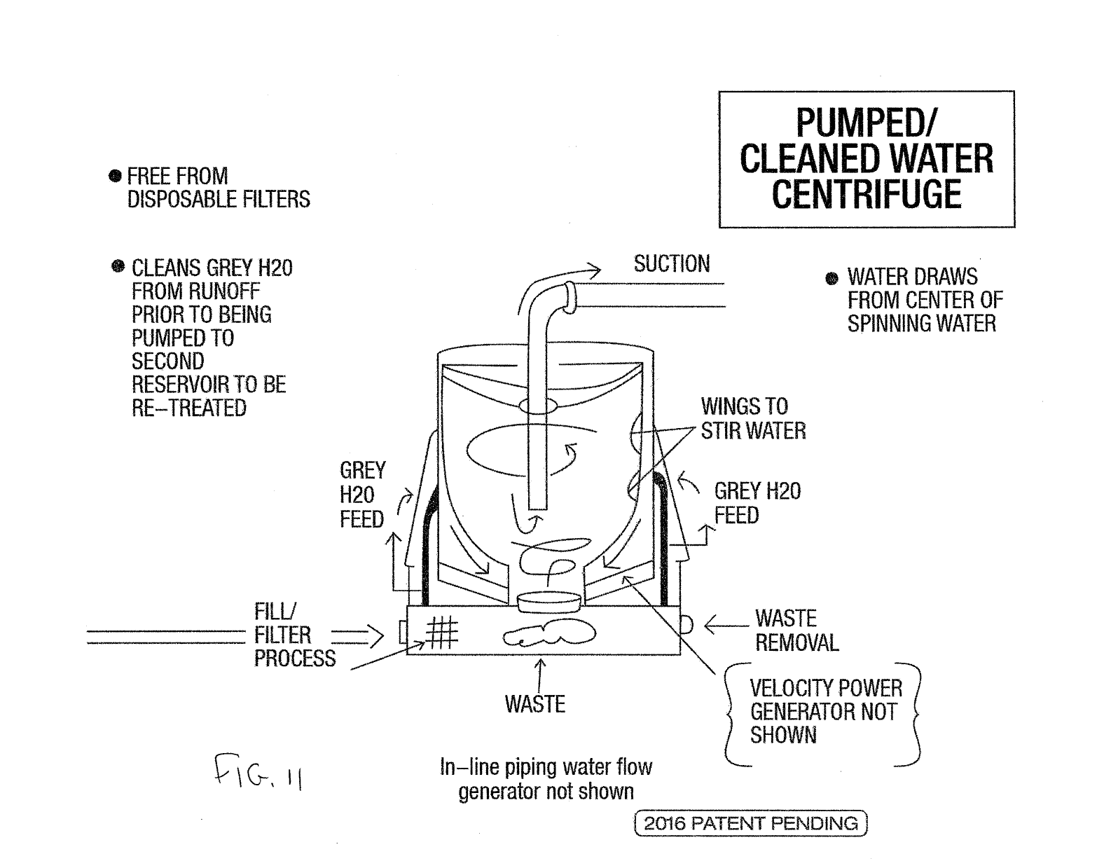

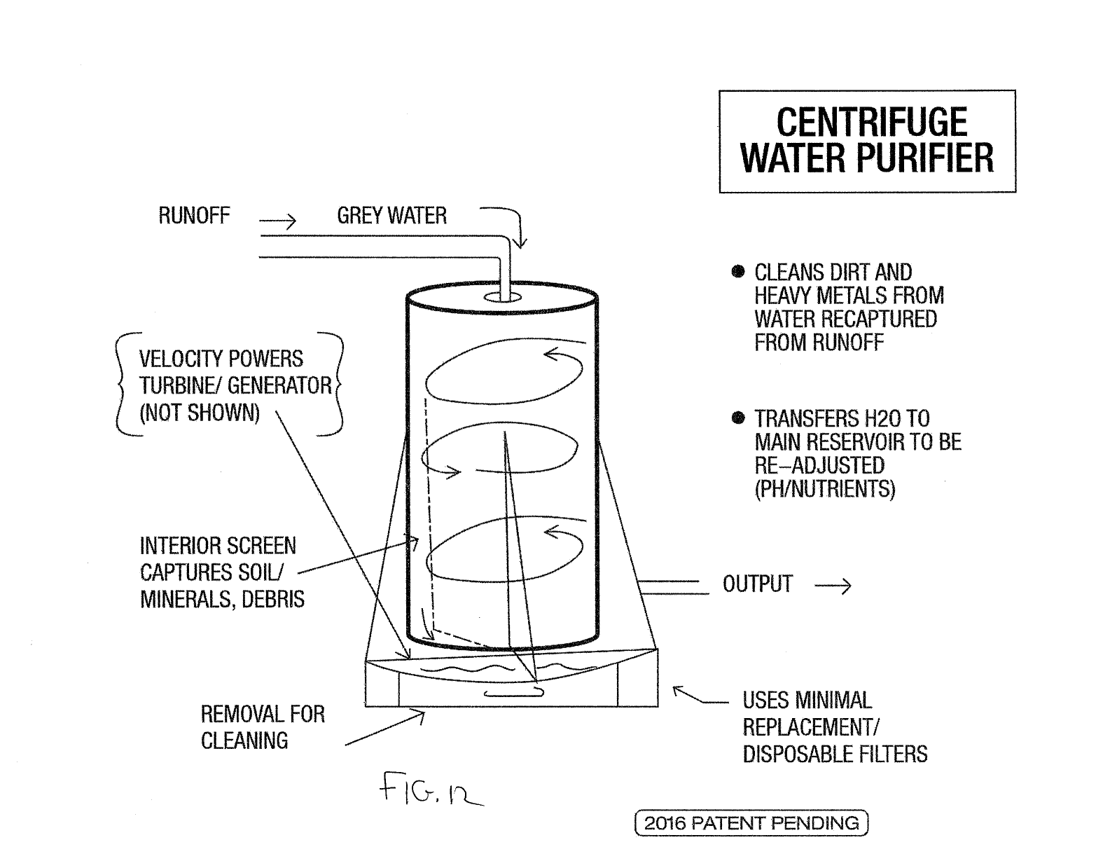

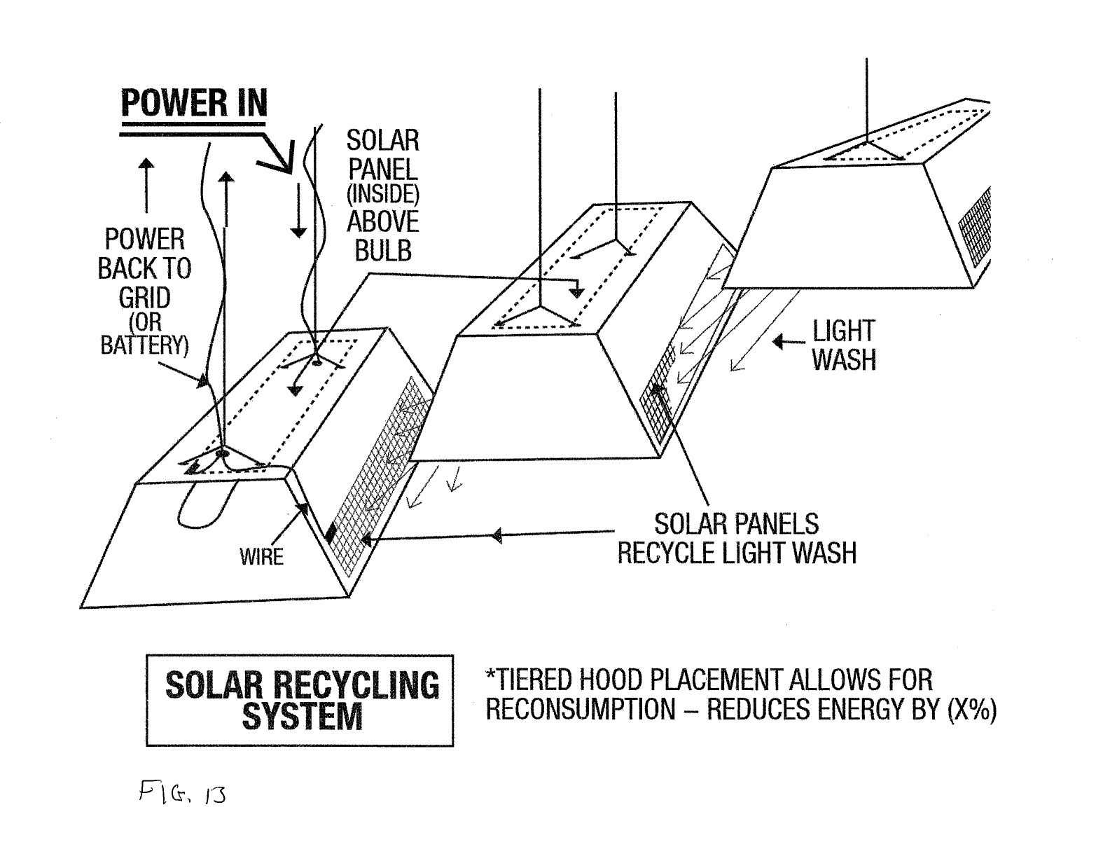

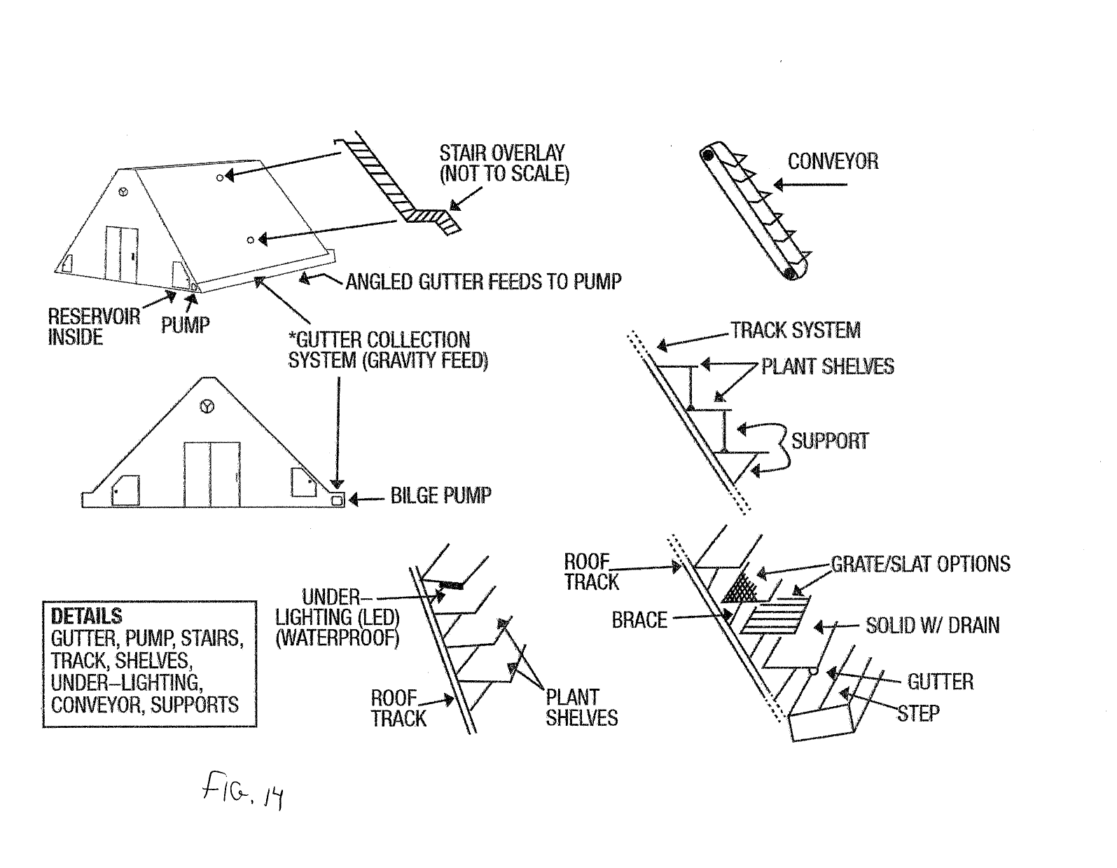

As shown in FIGS. 1 and 2, within an overall building or structure with a high ceiling (FIG. 1) is located a secondary structure or series of tiered structures of the growth efficiency system (FIG. 2) of the present invention. The secondary structures B inside of the overall structure A is purposed as a self-contained environment inside, and also serves the purpose of supporting horticulture activities in within the environment of the overall structure. The purpose of this design, among other things, is to reduce the overall square footage, currently needed to support two separate growing environments side by side as depicted in FIGS. 3 and 4. Advantages of the use of the tiered structures include, but are not limited to, reduced HVAC costs, two separate lighting cycles in each environment, etc, providing for recycling of light and water, etc. Within the interior B1 of the tiered structure there may be a series of systems, which can include but are not limited to; lighting, irrigation, HVAC, etc. The environment exterior to the tiered structures and within the main building may also include a similar series of systems, including but not limited to lighting, irrigation, HVAC, etc.

As shown in FIG. 5, the tiered structures may be built as modular units that may be detachably joined together (E) and arranged to take advantage of gravity for water runoff, which may be used to water plants or hydroponic systems, with the goal of recycling or otherwise collecting said runoff of water to provide for goals such as humidity control or reuse and treatment of the water as shown in FIGS. 6, 7 and 9 and with greater detail of example water treatment subsystems in FIGS. 11 and 12. Above the tiered structures B within the main building depicted in FIG. 8 is a lighting system that may be hung from the ceiling of the main building in a stepped manner as shown or otherwise arranged in a series of ways and angles to provide a light source to facilitate the growth of horticulture products, including but not limited to cannabis. The various arrangements may provide for the capture of light by mechanisms such as solar cells to recycle excess light, and recycle that energy through various systems of capture and storage, wiring, etc. with the goal of reducing energy costs. See for example, D1 generally in FIG. 8 and FIG. 13 for detail.

The modular units of the tiered structures B can be made of one or more materials suitable for the environment and application. They can be of various selectable size, style and shape and can expand to create a larger overall unit to support a larger cultivation effort, customized by adding or subtracting modular units. The main building used to contain one or more tiered structures therein may be customized to include rooms such as office space, storage, and other facilities to support the horticulture activity or otherwise needed services, including but not limited to quarantine rooms to prevent insect from entering, bathroom facilities, etc. as generally represented in FIG. 9. A series of shelves, steps, levels or other methods of supporting activity on and above the tiered structures may be included, such as, for example, shelves supported by a track system, and supported by such things as stairs, conveyors to assist in lifting items by a person and manually place them on the structure, etc. Examples of such components are represented in FIG. 14.

Within the interior environments (A1, B1), a series of carts on wheels or glides may be incorporated to assist in the management of horticulture or other activities within the interior structure, and may include track systems or other controls to facilitate the movement of the carts such as shown in FIG. 8. The growth efficiency system of the present invention may also include various features such as filtration systems, fans, filters or centrifuges, reservoirs, pumps, pipes, hoses and other methods that support the irrigation efforts and activities including the recycling of water or air as illustrated in the drawings.

The system of the present invention can be used to enhance the efficiency of plant growth and minimize the expense related thereto. Examples of components and configurations are described herein. The invention is not limited thereto and covers reasonable equivalents in view of the following appended claims.

What is claimed is:

1. A system to improve plant growth, the system comprising:
a building having an interior and an interior ceiling;
a series of tiered structures configured in a stepped manner within the building interior;
a plurality of lights hung from the ceiling of the building in a stepped manner to mirror the stepped manner of the tiered structures; and
a series of shelves positioned on the tiered structures and arranged to place a plurality of horticulture products thereon.

2. The system of claim 1 wherein the plurality of lights are powered by solar cells.

3. The system of claim 1 wherein the size, style and shape of the tiered structures are selectable.

4. The system of claim 1 wherein the series of shelves are supported on a track system to assist in lifting the horticulture products.

5. The system of claim 1 further comprising a series of carts for movement of the horticulture products to and from the series of shelves.

6. The system of claim 1 further comprising filtration systems, fans, filters, centrifuges, reservoirs, pumps, pipes and hoses.

7. The system of claim 1 further comprising a watering system including a manifold and a gutter system integrated with the tiered structures.

8. The system of claim 1 further comprising a water purifier.

9. The system of claim 1 wherein the lights are arranged within a solar recycling system.
